(19) United States
(12) Patent Application Publication
(10) Pub. No.: US 2013/0004874 A1
(43) Pub. Date: Jan. 3, 2013

(54) FUEL CELL SYSTEM

(75) Inventors: Ryoichi Nanba, Susono-shi (JP); Yasushi Araki, Gotenba-shi (JP)

(73) Assignee: TOYOTA JIDOSHA KABUSHIKI KAISHA, TOYOTA-SHI, AICHI (JP)

(21) Appl. No.: 13/260,967

(22) PCT Filed: Jan. 28, 2011
(86) PCT No.: PCT/JP11/51777

§ 371 Date: Jan. 20, 2012

(51) Int. Cl. H01M 8/04

(52) U.S. Cl. 429/432; 429/450

(57) ABSTRACT

A fuel cell system including a fuel cell and operated under a non-humidified condition is provided. The fuel cell includes a polymer electrolyte membrane sandwiched between an anode electrode and a cathode electrode, a fuel gas channel supplying the anode electrode with fuel gas containing at least a fuel component, and an oxidant gas channel supplying the cathode electrode with oxidant gas containing at least an oxidant component. The flow directions of the fuel gas and the oxidant gas are opposite each other. In addition, the fuel cell system has a moisture state control means which controls a flow rate and/or pressure of the fuel gas so that once a moisture state in an inlet region of the fuel gas channel is changed to a low moisture state side which is lower than a target moisture state, it is changed from the low moisture state to the target moisture state.

### TECHNICAL FIELD

The present invention relates to a fuel cell system comprising a solid polymer electrolyte fuel cell. Especially, it relates to a fuel cell system which operates the fuel cell under a non-humidified condition and which can avoid the inside of the fuel cell from being in a dry state even in high temperature operation and thus can stably generate electricity.

### BACKGROUND ART

A fuel cell converts chemical energy directly to electrical energy by supplying a fuel and an oxidant to two electrically-connected electrodes and causing electrochemical oxidation of the fuel. Unlike thermal power generation, fuel cells are not limited by Carnot cycle, so that they can show high energy conversion efficiency. In general, a fuel cell is formed by stacking a plurality of single fuel cells each of which has a membrane electrode assembly as a fundamental structure, in which an electrolyte membrane is sandwiched between a pair of electrodes. Especially, a solid polymer electrolyte fuel cell which uses a solid polymer electrolyte membrane as the electrolyte membrane is attracting attention as a portable and mobile power source because it has such advantages that it can be downsized easily, operated at low temperature, etc.

In a solid polymer electrolyte fuel cell, the reaction represented by the following formula (A) proceeds at an anode electrode (fuel electrode) in the case of using hydrogen as fuel:

H₂→2H⁺+2e⁻ Formula (A)

Electrons generated by the reaction represented by the formula (A) pass through an external circuit, work by an external load, and then reach a cathode electrode (oxidant electrode). Protons generated by the reaction represented by the formula (A) are, in the state of being hydrated and by electro-osmosis, transferred from the anode electrode side to the cathode electrode side through the solid polymer electrolyte membrane.

In the case of using oxygen as an oxidant, the reaction represented by the following formula (B) proceeds at the cathode electrode:

2H⁺+(½)O₂+2e⁻→H₂O Formula (B)

Water produced at the cathode electrode passes through a gas channel and so on and is discharged to the outside. Accordingly, fuel cells are clean power source that produces no emissions except water.

In a solid polymer electrolyte fuel cell, the electricity generation performance is largely affected by the amount of water in the electrolyte membrane and electrodes. In particular, if the water (emission) is excessive, the water condensed inside the fuel cell fills a void in the electrodes and, further, the gas channels to interrupt the supply of reaction gases (fuel gas and oxidant gas), so that the reaction gases for electricity generation are not sufficiently distributed throughout the electrodes. As a result, there is a problem that there is an increase in concentration overvoltage and thus a decrease in power output and electricity generation efficiency of the fuel cell. On the other hand, if the water inside the fuel cell is insufficient and thus the electrolyte membrane and electrodes are dried, there is a decrease in proton (H⁺) conductivity of the electrolyte membrane and electrodes. As a result, there is a problem that there is an increase in resistance overvoltage and thus a decrease in power output and electricity generation efficiency of the fuel cell.

Also in the solid polymer electrolyte fuel cell, a non-uniform distribution of water occurs in a plane direction of the electrolyte membrane (that is, a plane direction of the electrodes), which means that water is unevenly distributed in the plane direction of the electrolyte membrane. As a result, a non-uniform distribution of electricity generation occurs in the plane direction of the electrolyte membrane, resulting in a further uneven distribution of water and thus a decrease in power output and electricity generation efficiency of the fuel cell.

As described above, to realize a solid polymer electrolyte fuel cell with high power output and high electricity generation efficiency, appropriate water control is very important. In order to avoid water shortage, especially so-called drying up (dry-up), it is proposed to supply humidified reaction gases. In this case, however, the above problems due to excessive water are more likely to occur. In addition, as a result of equipping the fuel cell with a humidifier, the fuel cell becomes larger and the fuel cell system becomes complex, for example.

Therefore, there has been an attempt to obtain stable electricity generation performance by appropriately controlling the moisture state of the fuel cell under a non-humidified condition in which the reaction gases are not humidified.

For example, Patent Literature 1 discloses a fuel cell system which is operated under a non-humidified condition and/or high temperature condition and which prevents in-plane moisture distribution of a fuel cell from occurring by determining the dry state near the inlet of an oxidizing agent gas channel based on the resistance of the fuel cell, the voltage of the fuel cell, or the pressure loss of the oxidizing agent gas, and then controlling the flow rate or pressure of the fuel gas based on the determination.

As a technique for controlling the moisture state in the fuel cell, for example, Patent Literature 2 discloses a fuel cell system which comprises a current sensor for measuring an output current value of the fuel cell, a voltage sensor for measuring an output voltage value of the fuel cell, and a storage means for memorizing the relationship between the output voltage value and output current value, the relationship being the basis for determining whether the operation state of the fuel cell is an optimum operating state or not, which retrieves an optimum voltage value corresponding to the measured current value measured by the current sensor from the storage means, and which determines that the moisture state of the fuel cell is a dry state when the difference between the retrieved optimum voltage value and the measured voltage value measured by the voltage sensor is larger than the preset threshold value.

Patent Literature 3 discloses a fuel cell system which comprises a measuring device for measuring voltage in a plurality of measuring points of the fuel cell, and which estimates the uneven distribution of water in the fuel cell based on the difference of moisture contents between the plurality of measuring points, which were estimated from the difference of the voltage values measured in different measuring points.

Patent Literature 4 discloses a fuel cell system which determines whether the execution condition for performing the moisture content state determination of the fuel cell is filled or not from the time sequential change of voltage of the fuel cell based on the drop width of voltage corresponding to transitional load increase, and which determines the moisture state of the fuel cell when the execution condition is determined to be filled, based on the drop width of the voltage and the time sequential change of the electric resistance of the fuel cell.

### CITATION LIST

### Patent Literature

Patent Literature 1: Japanese Patent Application Laid-Open (JP-A) No. 2009-259758
Patent Literature 2: JP-A No. 2010-114039
Patent Literature 3: JP-A No. 2009-193817
Patent Literature 4: JP-A No. 2009-117066

### SUMMARY OF INVENTION

### Technical Problem

However, it is not possible for the moisture control technique of conventional fuel cells to sufficiently avoid the occurrence of a dry state inside them. For example, the technique disclosed in Patent Literature 1 can inhibit a dry-up around the inlet of the oxidant gas channel which is likely to occur under a non-humidified condition or high temperature condition. However, the technique is a feed back control which controls the flow rate and pressure of fuel gas based on the detected voltage and resistance of a fuel cell and pressure loss; therefore, the inside of the fuel cell could be temporarily in a dry state. Once the electrolyte membrane or electrodes of the fuel cell are in a dry state (dry-up), there are problems that it takes time to be in the optimum moisture state, that is, recovery of electricity generation performance takes time, and deterioration of the materials of the electrolyte membrane and electrodes is accelerated once they are in the dry state. Therefore, the occurrence of a dry-up inside the fuel cell should be avoided even if it is a temporary phenomenon.

The present invention was made in view of the above circumstances, and it is an object of the present invention to provide a fuel cell system which can prevent the occurrence of a dry-up inside the fuel cell, especially a dry-up around the inlet of the oxidant gas channel.

### Solution to Problem

A fuel cell system of the present invention comprises a fuel cell and is operated under a non-humidified condition,

the fuel cell comprising:

a polymer electrolyte membrane sandwiched between an anode electrode and a cathode electrode,

a fuel gas channel disposed so as to face the anode electrode in order to supply the anode electrode with fuel gas containing at least a fuel component, and

an oxidant gas channel disposed so as to face the cathode electrode in order to supply the cathode electrode with oxidant gas containing at least an oxidant component,

wherein a flow direction of the fuel gas in the fuel gas channel and a flow direction of the oxidant gas in the oxidant gas channel are opposite; and

wherein the fuel cell system has a moisture state control means which controls a flow rate and/or pressure of the fuel gas so that once a moisture state in an inlet region of the fuel gas channel is changed from the latest moisture state toward a low moisture state side which is lower than a target moisture state, it is changed from the low moisture state to the target moisture state.

According to the fuel cell system of the present invention, it is possible to appropriately control the moisture content in the plane direction of the electrolyte membrane of the fuel cell so as to avoid that the inlet of the oxidant gas channel is in a dry-up state and so that uniform electricity generation proceeds in the plane direction.

The moisture state control means can change the flow rate and/or pressure of the fuel gas by a given amount in order to change the moisture state toward the low moisture state side; thereafter, based on an amount of change in a predetermined parameter, which is associated with the given amount of change, it changes the flow rate and/or pressure of the fuel gas by a given amount in order to further change the moisture state toward the low moisture state side.

Once the moisture state control means increases the flow rate of the fuel gas toward a high fuel gas flow rate side which is higher than a target fuel gas flow rate, it can decrease the flow rate of the fuel gas from the high fuel gas flow rate to the target fuel gas flow rate.

In the fuel cell system of the present invention, the target fuel gas flow rate can be preliminarily obtained based on a correlation between a voltage of the fuel cell and the flow rate and/or pressure of the fuel gas in the fuel cell at a given temperature.

The fuel cell system of the present invention may comprise a voltage measuring means for measuring the voltage of the fuel cell, wherein the moisture state control means can end the process of controlling the flow rate and/or pressure of the fuel gas so as to change the moisture state from the low moisture state to the target moisture state when it determines by the voltage measuring means that the voltage of the fuel cell reaches a target voltage.

The fuel cell system of the present invention may comprise a voltage measuring means for measuring the voltage of the fuel cell, wherein the moisture state control means may have a calculation means which calculates a ratio of an amount of change in the voltage of the fuel cell to an amount of change in the flow rate or pressure of the fuel gas changed by the moisture state control means, based on the voltage of the fuel cell measured by the voltage measuring means, and wherein the moisture state control means can repeat the control of the flow rate and/or pressure of the fuel gas for changing the moisture state from the latest moisture state toward the low moisture state side, until the ratio is in a given range.

The moisture state control means can control the flow rate and/or pressure of the fuel gas so that once a water vapor amount at an outlet of the fuel gas channel is changed toward a high fuel gas outlet water vapor amount side which is higher than a target fuel gas outlet water vapor amount, it is decreased from the high fuel gas outlet water vapor amount to the target fuel gas outlet water vapor amount.

In the fuel cell system of the present invention, the target fuel gas outlet water vapor amount can be preliminarily obtained based on a correlation between the voltage of the fuel cell and the flow rate and/or pressure of the fuel gas in the fuel cell at a given temperature.

The fuel cell system of the present invention may comprise a water vapor amount measuring means for measuring the water vapor amount at the outlet of the fuel gas channel, wherein the moisture state control means can end the process of controlling the flow rate and/or pressure of the fuel gas when it determines by the water vapor amount measuring means that the water vapor amount at the fuel gas channel outlet is changed from the high fuel gas outlet water vapor amount to the target fuel gas outlet water vapor amount.

In the fuel cell system of the present invention, the moisture state control means can start the control of the flow rate and/or pressure of the fuel gas when the fuel cell reaches a temperature of 70° C. or more. According to the present invention, therefore, even under the condition of a temperature of 70° C. or more at which a dry-up is likely to occur, it is possible to keep the moisture state of the fuel cell optimal.

### Advantageous Effects of Invention

The fuel cell system of the present invention can provide high voltage; moreover, it can certainly prevent the occurrence of a dry-up, thereby showing a stable electricity generation performance even when operated under a high temperature condition.

### BRIEF DESCRIPTION OF DRAWINGS

FIG. 1 is a graph showing a relationship between a fuel gas average flow rate, fuel cell voltage and fuel cell resistance.

FIG. 2 is a graph showing a relationship between a fuel gas outlet water vapor amount and the fuel gas average flow rate.

FIG. 3 is a view showing an illustrative embodiment of the fuel cell system of the present invention, embodiment 100.

FIG. 4 is a sectional view showing a structural example of a single fuel cell in the fuel cell system of the present invention.

FIG. 5 is a view showing a control flow example of a moisture state control means in fuel cell system 100.

FIG. 6 is a view showing a method for determining k₁ and k₂ in the control flow shown in FIG. 5.

FIG. 7 is a view showing an illustrative embodiment of the fuel cell system of the present invention, embodiment 101.

FIG. 8 is a view showing a control flow example of a moisture state control means in fuel cell system 101.

### DESCRIPTION OF EMBODIMENTS

The fuel cell system of the present invention comprises a fuel cell and is operated under a non-humidified condition,

the fuel cell comprising:

a polymer electrolyte membrane sandwiched between an anode electrode and a cathode electrode,

a fuel gas channel disposed so as to face the anode electrode in order to supply the anode electrode with fuel gas containing at least a fuel component, and

an oxidant gas channel disposed so as to face the cathode electrode in order to supply the cathode electrode with oxidant gas containing at least an oxidant component,

wherein a flow direction of the fuel gas in the fuel gas channel and a flow direction of the oxidant gas in the oxidant gas channel are opposite; and

wherein the fuel cell system has a moisture state control means which controls a flow rate and/or pressure of the fuel gas so that once a moisture state in an inlet region of the fuel gas channel is changed from the latest moisture state toward a low moisture state side which is lower than a target moisture state, it is changed from the low moisture state to the target moisture state.

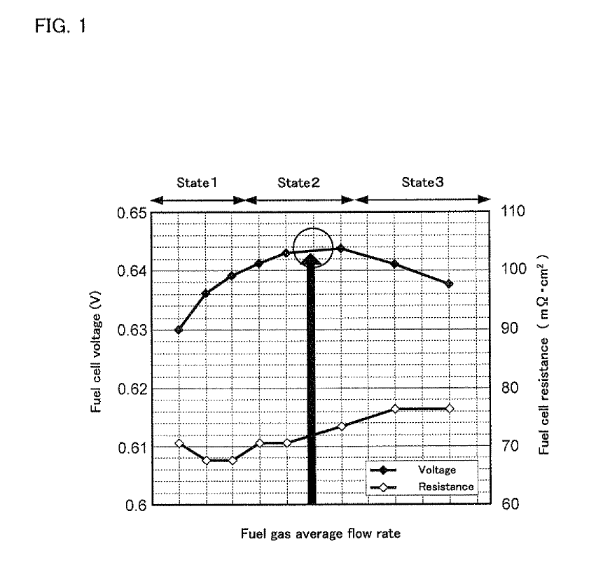

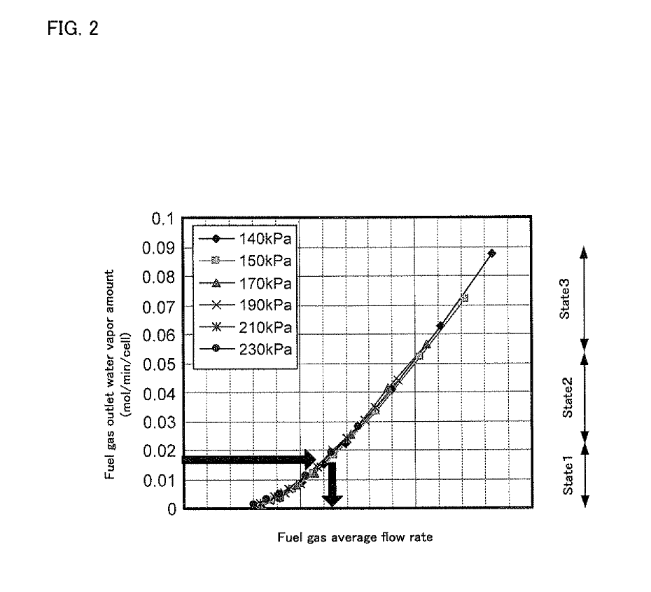

A so-called counter-flow fuel cell, in which the flow direction of the fuel gas in the fuel gas channel and the flow direction of the oxidant gas in the oxidant gas channel are opposite, was operated by the inventors of the present invention under the non-humidified condition to measure an amount of water vapor contained in the fuel gas which passes through an outlet of the fuel gas channel (hereinafter may be referred to as fuel gas outlet water vapor amount), while measuring a voltage and resistance of the fuel cell when the average flow rate of the fuel gas in the fuel gas channel (hereinafter may be referred to as fuel gas average flow rate) is changed. Therefore, results shown in FIGS. 1 and 2 were obtained. FIG. 1 is a view showing a relationship between the fuel gas average flow rate, the fuel cell voltage and the fuel cell resistance. FIG. 2 is a view showing a relationship between the fuel gas average flow rate and the fuel gas average flow rate. States 1 to 3 in FIG. 1 correspond to those in FIG. 2. In states 1 to 3, the following relationships were observed between the fuel gas outlet water vapor amount, the fuel cell voltage and the fuel cell resistance.

In particular, when the amount of water vapor discharged from the fuel gas channel outlet is very small, the fuel cell voltage is decreased (state 1).

The state in which, as just described, the fuel gas outlet water vapor amount is very small is a state in which a region around an inlet of the oxidant gas channel (that is, the region around the fuel gas channel outlet) in the plane direction of the electrolyte membrane of the fuel cell is dried (that is, the plane direction of the electrodes which is a direction perpendicular to the stacking direction of the electrolyte membrane and the electrodes); thus, no electricity is generated in the region. Electricity is intensively generated in a region around an outlet of the oxidant gas channel (that is, the region around the fuel gas channel inlet). At this time, water vapor on the anode electrode side moves to the cathode electrode side in a dry state to relieve dryness on the cathode electrode side; therefore, the fuel gas outlet water vapor amount is considered to be low. In the region around the oxidant gas channel inlet, there is an increase in resistance overvoltage due to drying, while there is an increase in concentration overvoltage in the region around the oxidant gas channel outlet due to a decrease in concentration of the oxidant component. It is considered that this is the reason why the fuel cell voltage becomes low.

When a small amount of water vapor is discharged from the fuel gas channel outlet, the fuel cell voltage is increased (state 2).

The state in which, as just described, a small amount of water vapor is discharged is a state in which the moisture state of the fuel cell is uniform and excellent in the plane direction of the fuel cell, so that uniform electricity is generated in the plane. Therefore, there is a decrease in concentration overvoltage and, further, there is a decrease in resistance overvoltage in the region around the oxidant gas channel outlet. It is considered that this is the reason why high voltage is obtained.

When the amount of water vapor discharged from the fuel gas channel outlet is large, the fuel cell voltage is decreased (state 3).

In the state in which, as just described, the fuel gas outlet water vapor amount is large, the region around the oxidant gas channel inlet in the plane direction of the fuel cell is in a sufficient moisture state, and the concentration of the oxidant component in this region is sufficient; therefore, it is considered that electricity is intensively generated. On the other hand, the region around the fuel gas channel inlet (that is, the region around the oxidant gas channel outlet) is dried because moisture is carried off by fuel gas to the fuel gas channel outlet side and the concentration of the oxidant component is low. Therefore, there is an increase in both resistance overvoltage and concentration overvoltage, so that a uniform distribution of electricity generation cannot be obtained in the plane. It is considered that this is the reason why the fuel cell voltage is decreased.

Based on the above results, the inventors of the present invention have found out that when the counter-flow fuel cell is operated under the non-humidified condition, it is possible to obtain a fuel cell system which prevents a dry-up, especially a dry-up in the inlet region of the oxidant gas channel from occurring and shows stable and high power output by controlling the flow rate and/or pressure of the fuel gas as follows upon drive-controlling the flow rate and/or pressure of the fuel gas under a given temperature condition in order to obtain a peak voltage.

In particular, the fuel cell system of the present invention controls the flow rate and/or pressure of the fuel gas so that once the moisture state in the inlet region of the fuel gas channel is changed from the latest moisture state toward the low moisture state side which is lower than the target moisture state, it is changed from the low moisture state to the target moisture state.

In the present invention, the target moisture state in the inlet region of the fuel gas channel is a moisture state in the inlet region of the fuel gas channel upon obtaining the peak voltage under a given temperature condition. The flow rate and/or pressure of the fuel gas is controlled toward the target moisture state in order to obtain the peak voltage. The target moisture state can refer to a moisture state at one point at which the peak voltage can be obtained or it can refer to a range in which the peak voltage can be obtained. For example, in FIG. 1, state 2 can be set as the target moisture state.

As the route of change of the moisture state upon drive-controlling the moisture state to the target moisture state in which the peak voltage can be obtained, for example, there are a route of changing the moisture state from state 1 to state 2 and a route of changing the state from state 3 to state 2 in FIG. 1.

As described above, state 1 is a state in which the inlet region of the oxidant gas channel is dried or is likely to be dried. When the counter-flow fuel cell is operated under the non-humidified condition, once the inlet region of the oxidant gas channel is in a dry-up state, it takes time for the inlet region to recover to the moisture state in which the inlet region shows excellent electric performance, or the inlet region is not recovered to the moisture state at which the region shows excellent electric performance. This is because supplying water vapor in the inlet region of the oxidant gas channel is less likely to result in a humidifying effect by water generated by cathode electrode reaction. In addition, the inlet region of the oxidant gas channel faces the outlet region of the fuel gas channel, interposing the electrolyte membrane therebetween. The amount of water vapor which is supplied to the fuel gas from the electrolyte membrane and anode electrode while the fuel gas flows through the fuel gas channel from the upstream side to the downstream side, is small, so that the amount of water vapor which is supplied to the electrolyte membrane and anode electrode from the fuel gas in the outlet region of the fuel gas channel, is also small. Therefore, once the inlet region of the oxidant gas channel is dried, it is less likely to be restored even if the pressure and flow rate of the fuel gas are changed. As a result, the electricity generation performance of the fuel cell is also less likely to be restored over a long time.

State 3 is a state in which the inlet region of the fuel gas channel is dried or is likely to be dried. In the counter-flow fuel cell, the inlet region of the fuel gas channel faces the outlet region of the oxidant gas channel, interposing the electrolyte membrane therebetween. The oxidant gas is humidified with water produced by the cathode electrode reaction, so that the amount of water vapor in the outlet region of the oxidant gas channel is large. Therefore, the dry state of the inlet region of the fuel gas channel is improved and resolved more rapidly than the dry state of the inlet region of the oxidant gas channel, resulting in rapid recovery of the electricity generation performance of the fuel cell.

In the present invention, therefore, the moisture state inside the fuel cell is drive-controlled to the target moisture state using the moisture state in the inlet region of the fuel gas channel as a criterion and through the route of changing the moisture state from state 3 to state 2, not the route of changing the state from state 1 to state 2. Thereby, it is possible to prevent the inlet region of the oxidant gas channel from drying and to stabilize the electricity generation performance of the fuel cell. Furthermore, because the electrolyte membrane is prevented from drying, the electrolyte membrane has a small swelling/shrinking ratio and it is possible to prevent the electrolyte membrane, electrodes, etc., from deterioration due to swelling and shrinking. Therefore, it is possible to increase power generation durability of the fuel cell.

Hereinafter, the fuel cell system of the present invention will be described with reference to figures.

The purpose of the fuel cell system of the present invention is not particularly limited and is usable as a source of electricity for driving mechanisms of transportation devices such as vehicles, vessels, or as a source of electricity for other various kinds of devices.

In the present invention, fuel gas is gas that contains a fuel component. It refers to gas that flows through the fuel gas channel in the fuel cell and it can contain a component other than the fuel component (e.g., water vapor, nitrogen gas). Oxidant gas is gas that contains an oxidant component. It refers to gas that flows through the oxidant gas channel in the fuel cell, and it can contain a component other than the oxidant component (e.g., water vapor, nitrogen gas). The fuel gas and oxidant gas may be collectively referred to as reaction gas.

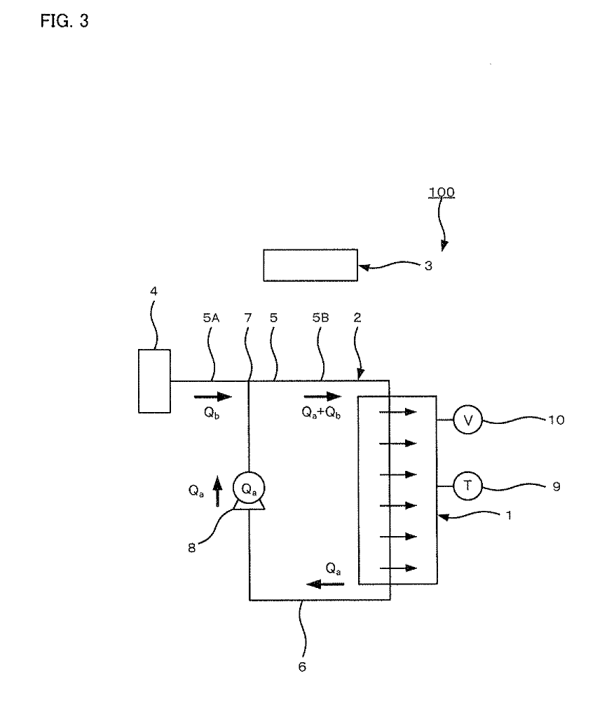

FIG. 3 is a view showing an illustrative embodiment of the fuel cell system of the present invention, fuel cell system 100.

Fuel cell system 100 comprises at least fuel cell 1 which generates electricity by supply of reaction gas, fuel gas piping system 2, an oxidant gas piping system (not shown) and controller 3 which integrally controls the fuel cell system.

The fuel cell system of the present invention comprises the oxidant gas piping system which supplies oxidant gas to the fuel cell and discharges gas containing an unreacted oxidant component, water vapor and so on (discharged oxidant gas) from the fuel cell. However, in the present invention, no particular limitation is imposed on the embodiment of the supply and discharge of the oxidant gas as long as the fuel cell is a counter-flow type fuel cell in which the flow direction of fuel gas which flows through the fuel gas channel and the flow direction of oxidant gas which flows through the oxidant gas channel are opposite. The oxidant gas piping system is omitted in the figures of the present invention, therefore.

Fuel cell 1 is composed of a solid polymer electrolyte fuel cell. In general, it has a stack structure in which a plurality of single fuel cells is stacked, and it generates electricity when supplied with oxidant gas and fuel gas. Oxidant gas and fuel gas are supplied to and discharged from fuel cell 1 through the oxidant gas piping system and fuel gas piping system 2. A detailed description of the fuel cell will be given below, using air containing oxygen as oxidant gas and hydrogen-containing gas as fuel gas.

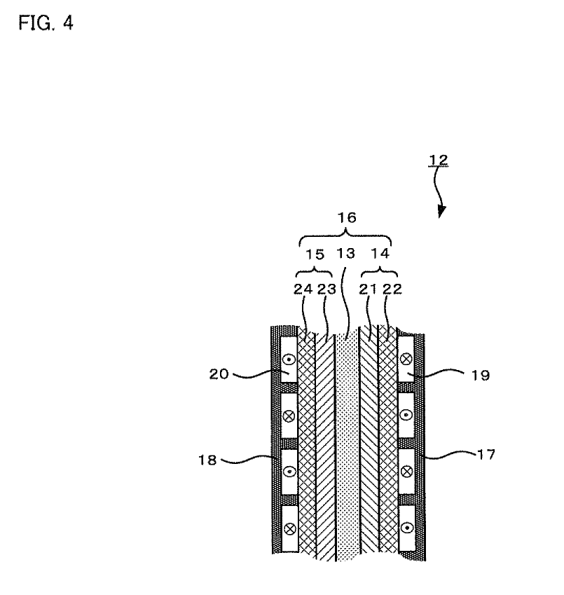

FIG. 4 is a schematic sectional view of single fuel cell 12 comprising fuel cell 1.

Single fuel cell 12 has a membrane electrode assembly 16 as the basic structure, in which solid polymer electrolyte membrane 13 is sandwiched between cathode electrode (air cathode) 14 and anode electrode (fuel electrode) 15. Cathode electrode 14 has a structure in which cathode catalyst layer 21 and gas diffusion layer 22 are stacked in this order from closest to electrolyte membrane 13, while anode electrode 15 has a structure in which anode catalyst layer 23 and gas diffusion layer 24 are stacked in this order from closest to electrolyte membrane 13.

Both sides of membrane electrode assembly 16 are sandwiched between a pair of separators 17 and 18 so that cathode electrode 14 and anode electrode 15 are sandwiched between the pair of separators 17 and 18. In separator 17 on the cathode side, a groove that forms an oxidant gas channel for supplying oxidant gas to cathode electrode 14 is provided, and oxidant gas channel 19 is defined by the groove and cathode electrode 14. In separator 18 on the anode side, a groove that forms a fuel gas channel for supplying fuel gas to anode electrode 15 is provided, and fuel gas channel 20 is defined by the groove and the anode.

Oxidant gas channel 19 and fuel gas channel 20 are disposed so that the flow direction of the oxidant gas that flows through oxidant gas channel 19 and the flow direction of the fuel gas that flows through fuel gas channel 20 are opposite (that is, a so-called counter-flow structure). In FIG. 4, a symbol of “circle with a dot” in oxidant gas channel 19 and fuel gas channel 20 refer to a gas flow direction to this side of the page showing FIG. 4 from the other side of the page, and a symbol of “circle with a cross mark” refer to a gas flow direction to the other side of the page showing FIG. 4 from this side of the page. Moreover, although it is not specifically shown in FIG. 4, a region around the inlet of oxidant gas channel 19 and a region around the outlet of fuel gas channel 20 are disposed to sandwich electrolyte membrane 1, while a region around the outlet of oxidant gas channel 19 and a region around the inlet of fuel gas channel 20 are disposed to sandwich electrolyte membrane 1. In FIG. 4, the gas channels are drawn as a serpentine channel each; however, the form of the gas channels is not particularly limited and the gas channels can be in any form as long as they have a counter-flow structure.

Members constituting the fuel cell are not particularly limited. Each of the members may be one which is formed with general materials and has a general structure.

Fuel cell 1 has temperature sensor (temperature measuring means) 9 which measures temperature T of fuel cell 1. Temperature sensor 9 may be one which directly measures the temperature inside the fuel cell, or one which measures the temperature of a heat exchange medium that flows inside the fuel cell.

In addition, fuel cell 1 has voltage sensor 10 which detects voltage V of a single fuel cell or a stack of single fuel cells.

Fuel gas piping system 2 comprises hydrogen tank 4, fuel gas supply path 5 and fuel gas circulating path 6. Hydrogen tank 4 is a hydrogen gas source in which high-pressure hydrogen gas (fuel component) is stored, and is also a fuel supply means. As the fuel supply means, for example, instead of hydrogen tank 4, there can be employed a reformer which produces hydrogen-rich reformed gas from hydrocarbon fuel, and a hydrogen storage alloy-containing tank in which reformed gas produced by the reformer is accumulated at high pressure.

Fuel gas supply path 5 is a path for supplying hydrogen gas (fuel component) to fuel cell 1 from hydrogen tank 4 (fuel supply means) and is composed of main path 5A and mixing path 5B. Main path 5A is located upstream of connecting part 7 which connects fuel gas supply path 5 with fuel gas circulating path 6. Main path 5A can be provided with a shutoff valve (not shown) which functions as a main valve of hydrogen tank 4, a regulator which reduces the pressure of hydrogen gas, etc. Flow rate Q_{b} of the hydrogen gas supplied from hydrogen tank 4 (the flow rate of fuel component gas) is controlled based on a required output for the fuel cell, and the required output is secured. Mixing path 5B is located downstream of connecting part 7 and leads mixed gas of the hydrogen gas from hydrogen tank 4 and the discharged fuel gas from fuel gas circulating path 6 to the fuel gas channel inlet of fuel cell 1.

Fuel gas circulating path 6 recirculates the discharged fuel gas discharged from the fuel gas channel outlet of fuel cell 1 to fuel gas supply path 5. Fuel gas circulating path 6 is provided with recirculation pump 8 for recirculating the discharged fuel gas to fuel gas supply path 5. As a result of hydrogen consumption by the fuel cell for electricity generation, the flow rate and pressure of the discharged fuel gas are lower than those of the fuel gas supplied to the fuel cell. Therefore, the flow and pressure of the discharged fuel gas are appropriately controlled by the recirculation pump to pump the discharged fuel gas to connecting part 7. The system composed of fuel gas circulating path 6, fuel gas supply path 5 and the fuel gas channel(s) in fuel cell 1 constitutes a circulation system which circulates and supplies fuel gas to the fuel cell.

The discharged fuel gas discharged from fuel cell 1 contains water produced by electricity generation reaction of the fuel cell, nitrogen gas transferred to the anode electrode side from the cathode electrode of the fuel cell through the electrolyte membrane (cross leaking), unconsumed hydrogen gas, etc. On fuel gas circulating path 6, a gas-liquid separator (not shown) can be installed on the upstream side of recirculation pump 8. The gas-liquid separator separates water and gas (such as unconsumed hydrogen gas) contained in the discharged fuel gas. Also on fuel gas circulating path 6, a discharged fuel gas pressure regulator (not shown) can be installed on the upstream side of recirculation pump 8, which discharges part of the discharged fuel gas to the outside of the fuel cell and adjusts the pressure of the discharged fuel gas to be recirculated.

From the viewpoint of efficient use of the hydrogen gas (fuel component), the fuel gas piping system preferably has a circulation system comprising a fuel gas circulating path, a recirculation pump, etc.; however, it can be provided with no circulation system or with a dead-end structure.

The oxidant gas piping system comprises an oxidant gas supply path which supplies oxidant gas to fuel cell 1, an oxidant gas discharge path which discharges discharged oxidant gas from fuel cell 1, and a compressor. The compressor is installed on the oxidant gas supply path. Air taken from the atmosphere by the compressor flows through the oxidant gas supply path and is pumped and supplied to fuel cell 1. The discharged oxidant gas discharged from fuel cell 1 flows through the oxidant gas discharge path and discharged to the outside of the fuel cell.

The operation of the fuel cell system is controlled by controller 3. Controller 3 is a microcomputer which comprises CPU, RAM, ROM and so on installed therein. In accordance with various kinds of programs and maps stored in ROM, RAM and so on, CPU executes various sorts of processing and control of various kinds of valves and pumps, the fuel gas piping system, the oxidant gas piping system, the heat exchange medium circulation system, etc., based on a required output for the fuel cell (output current density, that is, size of the load connected to the fuel cell) and results measured by several sensors connected to the fuel cell such as a temperature sensor, a gas pressure sensor, a gas flow sensor, a voltage sensor and a dew-point meter.

A main feature of fuel cell system 100 is that controller 3 has the moisture state control means which controls the flow rate and/or pressure of the fuel gas so that once the moisture state in the inlet region of the fuel gas channel is changed from the latest moisture state toward the low moisture state side which is lower than the target moisture state, it is changed from the low moisture state to the target moisture state.

In the present invention, the moisture state in the inlet region of the fuel gas channel means a moisture state (wet state) of the region around the inlet of the fuel gas channel in the fuel cell. In particular, it means the moisture state of the anode electrode and electrolyte membrane around the fuel gas channel inlet, and that of the cathode electrode which faces the anode electrode around the inlet, interposing the electrolyte membrane therebetween. The moisture state inside the fuel cell varies depending on operating conditions of the fuel cell, such as the temperature of the fuel cell, the flow rate and pressure of the fuel gas, and the flow rate and pressure of the oxidant gas. The moisture state can be controlled by the above conditions.

In the present invention, the moisture state inside the fuel cell is controlled by the flow rate and/or pressure of the fuel gas since the control is easy and response to the control is quick. Especially due to the quick response to the control, the moisture state control means preferably controls the moisture state inside the fuel cell by the flow rate of the fuel gas.

In particular, once the moisture state control means increases the flow rate of the fuel gas toward a high fuel gas flow rate side which is higher than a target fuel gas flow rate, it decreases the flow rate of the fuel gas from the high fuel gas flow rate to the target fuel gas flow rate. Thereby, the moisture state in the inlet region of the fuel gas flow rate can be changed to the target moisture state through the above-mentioned route.

The target fuel gas flow rate is a flow rate of the fuel gas which can achieve the target moisture state of the inlet of the fuel gas channel. The target fuel gas flow rate can be preliminarily obtained based on a correlation between a voltage of the fuel cell and the flow rate and/or pressure of the fuel gas in the fuel cell at a given temperature. Or, it can be set based on the correlation between the actual fuel cell voltage when operating the fuel cell and the actual flow rate and/or pressure of the fuel gas in the fuel cell at a given temperature when operating the fuel cell. Or, the correlation can be stored and set as the target value of the subsequent controls. As with the target moisture state, the target fuel gas flow rate can refer to a flow rate at one point at which the target moisture state can be achieved (the peak voltage can be obtained), or it can refer to a range in which the target moisture state can be achieved (the peak voltage can be obtained).

The pressure of the fuel gas is also changed with the control of the fuel gas flow rate. Therefore, it is expected that the moisture state inside the fuel cell can be brought close to the target moisture state more efficiently by controlling both the flow rate and pressure of the fuel gas.

In the case of controlling the pressure of the fuel gas, a pressure sensor can be installed in fuel cell 1 as needed, which measures the pressure of the fuel gas that flows through the fuel gas channel. The installation position of the pressure sensor is not specifically limited as long as it can measure the pressure of the fuel gas in the fuel gas channel at a desired position. For example, an inlet pressure sensor for measuring the pressure of the fuel gas at the inlet is installed in the inlet of the fuel gas channel, while an outlet pressure sensor for measuring the pressure of the fuel gas at the outlet is installed in the outlet of the fuel gas channel. Then, fuel gas inlet pressure Pᵢₙ and fuel gas outlet pressure Pₒᵤₜ are detected by the pressure sensors and the average of these pressures can be detected and controlled as the fuel gas pressure. The installation position is not limited to the inlet and outlet of the fuel gas channel. Pressure sensors can be installed in several positions of the fuel gas channel, and fuel gas pressures can be detected at the positions and controlled. Or, an average can be calculated from the detected fuel gas pressures and controlled as the pressure of the fuel gas. Only one pressure sensor can be installed in the fuel cell. Also, the pressure of the fuel gas can be estimated by a pressure sensor installed on the outside of the fuel gas channel.

The pressure of the fuel gas can be controlled by controlling, for example, the pressure of the fuel gas at the inlet of the fuel gas channel and/or the pressure of the fuel gas at the outlet of the fuel gas channel. In particular, the pressure of the fuel gas can be controlled by a back pressure valve installed on the downstream side of the fuel gas channel outlet, a regulator for supplying hydrogen to the fuel cell from the hydrogen tank, or, in the case where the fuel gas piping system is a circulation system, an injector for supplying hydrogen to the piping system from the hydrogen tank or a circulation pump installed in the piping system.

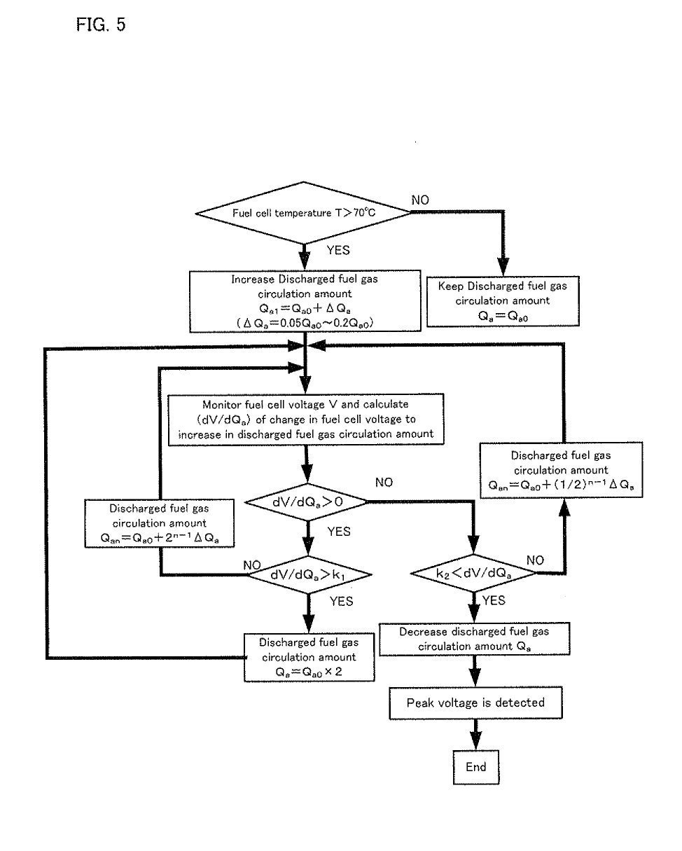

FIG. 5 shows a specific control flow example of the moisture state control means in fuel cell system 100. In the control flow shown in FIG. 5, the moisture state inside the fuel cell is controlled by controlling a circulation amount of the discharged fuel gas and thereby controlling the fuel gas flow rate.

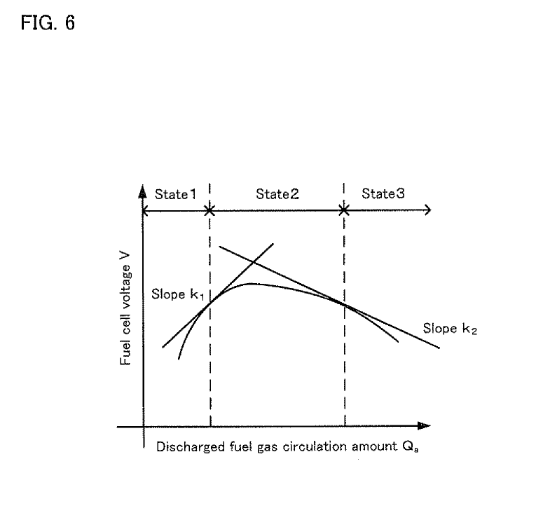

In the control flow in FIG. 5, the circulation amount of the discharged fuel gas is determined based on ratios (k₁ and k₂) of change in the voltage of the fuel cell to change in the circulation amount of the discharged fuel gas. k₁(k₁>0) and k₂(k₂<0) can be appropriately determined and they can be preliminarily determined based on the correlation between circulation amount Qₐ of the discharged fuel gas and voltage V as shown in FIG. 6, for example. In FIG. 6, the point of contact between a curve showing the correlation between circulation amount Qₐ and voltage V and a tangent having slope k₁ can be the border between state 1 and state 2 (target moisture state). Also, the point of contact between the curve and a tangent of tilt k₂ can be the border between state 2 (target moisture state) and state 3 (low moisture state).

First, in the operation of fuel cell 1, the moisture state control means of controller 3 detects temperature T of fuel cell 1 by temperature sensor 9 to determine whether temperature T is 70° C. or less or more than 70° C.

If temperature T is 70° C. or less, the moisture state control means does not change circulation amount Qₐ of the discharged fuel gas and keeps the latest circulation amount Qₐ₀ of the discharged fuel gas.

On the other hand, if temperature T is more than 70° C., the moisture state control means increases circulation amount Qₐ of the discharged fuel gas by ΔQₐ from the latest circulation amount Qₐ₀ to Qₐ₀+ΔQₐ. ΔQₐ can be appropriately determined; however, it is preferably, for example, within the range of 5% to 20% of Qₐ₀ in order to prevent the inside of the fuel cell from being in an excessively-dry state.

Next, the moisture state control means monitors fuel cell voltage V by voltage sensor 10 to calculate a ratio (dV/dQₐ) of the amount of change in fuel cell voltage V to increase ΔQₐ in the circulation amount of the discharged fuel gas.

Then, it is determined whether the calculated dV/dQₐ is more than 0 or not, that is, whether voltage V is increased by increase ΔQₐ (dV/dQₐ>0), or voltage V is decreased or not changed by increase ΔQₐ (dV/dQₐ≦0).

If dV/dQₐ is more than 0, it is further determined whether dV/dQₐ is more than k₁ or not, that is, whether the moisture state inside the fuel cell is state 1 or state 2. If dV/dQₐ is more than k₁, circulation amount Qₐ of the discharged fuel gas is increased to twice the latest circulation amount Qₐ₀, and the means returns to the step of calculating dV/dQₐ, again. If dV/dQₐ is k₁ or less, increase ΔQₐ in the circulation amount of the discharged fuel gas is doubled compared to the last ΔQₐ, and the means returns to the step of calculating dV/dQₐ, again.

On the other hand, if dV/dQₐ is 0 or less, it is further determined whether dV/dQₐ is smaller than k₂ or not, that is, whether the moisture state inside the fuel cell is state 3 or state 2. If dV/dQₐ is k₂ or more, increase ΔQₐ in the circulation amount of the discharged fuel gas is reduced by half of the last ΔQₐ, and the means returns to the step of calculating dV/dQₐ, again. If dV/dQₐ is smaller than k₂, circulation amount Qₐ of the discharged fuel gas is decreased until the peak voltage is detected by voltage sensor 10, and then the moisture state control means ends the process. The discharged fuel gas circulation amount at the time when dV/dQₐ is determined to be smaller than k₂, can be stored and reflected in the subsequent moisture state controls.

In the control flow shown in FIG. 5, the moisture state control means starts control when the fuel cell temperature reaches a temperature of 70° C. or more. This is because, under such a high temperature operating condition as 70° C., the inside of the fuel cell is likely to be dried, so that a dry-up is likely to occur in the inlet region of the oxidant gas channel. The temperature which triggers the control of the moisture state control means is not particularly limited; however, the control is preferably started when the fuel cell reaches a temperature of 70° C. or more, more preferably 80° C. or more.

The control by the moisture state control means of the present invention can be started not only when the fuel cell temperature is changed but also when other operating conditions of the fuel cell (e.g., pressure and/or flow rate of reaction gas, etc.) are changed with the change in required output, etc.

The control can be started when the performance of the fuel cell is changed with the deterioration of the fuel cell. There is a possibility that the conditions for putting the moisture state inside the fuel cell in a state in which the peak voltage can be obtained, are changed as a result of change in the performance of the fuel cell. Therefore, it is possible to optimize the operating conditions appropriately depending on the deterioration of the fuel cell by operating the moisture state control means when the performance of the fuel cell is changed or expected to be changed. In the case of starting the control when the performance is changed, it is possible to operate the moisture state control means automatically or in response to a fuel cell users' request, using the operating time of the fuel cell, the mileage or driving time of a vehicle equipped with the fuel cell, etc., as a measure of the change in the performance.

In the control flow shown in FIG. 5, when it is determined by the voltage sensor that the voltage of the fuel cell reaches a target voltage (peak voltage), the moisture state control means ends the process of controlling the flow rate of the fuel gas so as to change the moisture state at the inlet of the fuel gas channel from the low moisture state to the target moisture state. In the present invention, however, a trigger to end the control process by the moisture state control means is not particularly limited. It is possible to end the process using the water vapor amount detected at the outlet of the fuel gas channel as a trigger, for example.

In the control flow shown in FIG. 5, the moisture state control means changes the flow rate of the fuel gas (the circulation amount of the discharged fuel gas) by a given amount (ΔQₐ) so that the moisture state in the inlet region of the fuel gas channel is changed from the latest moisture state toward the low moisture state side, and then based on an amount of change in a predetermined parameter (fuel cell voltage), which is associated with the given amount of change, the moisture state control means changes the flow rate of the fuel gas (the circulation amount of the discharged fuel gas) by a given amount so that the moisture state is further changed toward the low moisture state side. As just described, by changing in stages a control parameter which is changed to control the moisture state inside the fuel cell (the flow rate and/or pressure of the fuel gas) as needed, based on the amount of change in a predetermined parameter which is changed in association with the amount of change in the control parameter, it is possible to control the moisture state inside the fuel cell more precisely and at the same time to efficiently drive-control the moisture state to the fuel cell operating condition in which the peak voltage can be obtained. Examples of the predetermined parameter which is the basis to control the control parameter include, in addition to the fuel cell voltage as shown in FIG. 5, the water vapor amount at the fuel gas channel outlet, etc.

In particular, in the control flow shown in FIG. 5, the moisture state control means has a calculation means which calculates a ratio (dV/dQₐ) of an amount of change in the voltage of the fuel cell to an amount of change in the flow rate of the fuel gas (the circulation amount of the discharged fuel gas) changed by the moisture state control means, based on the voltage of the fuel cell measured by the voltage sensor, and the moisture state control means repeats the control of the flow rate of the fuel gas for changing the moisture state from the latest moisture state toward the low moisture state side, until the ratio is in a given range (k₂<dV/dQₐ). Thus, it is possible to efficiently bring the fuel cell voltage the peak voltage (target voltage) by controlling the flow rate and/or pressure of the fuel gas by the moisture state control means based on the ratio of the amount of change in the fuel cell voltage to the amount of change in the control parameter(s) (the flow rate and/or pressure of the fuel gas).

In the case of the above-described circulation system which circulates the discharged fuel gas, by controlling recirculation flow rate Qₐ of the discharged fuel gas recirculated by recirculation pump 8 and not by controlling flow rate Q_{b} of the fuel component gas supplied from hydrogen pump 4 (fuel source) by a water vapor amount control means, it is possible to sufficiently secure a required output and, further, to increase the use efficiency of hydrogen (fuel component) and thus to effectively control water distribution in the fuel cell.

The form of control of the fuel gas flow rate by the moisture state control means is not particularly limited as long as a required output for the fuel cell is secured. For example, the flow rate of the fuel gas can be controlled by controlling supply amount Q_{b} of the hydrogen gas supplied from the fuel source only, or by controlling both Qₐ and Q_{b}, after securing a required output. It is also possible to use other means which can control the flow rate of the fuel gas.

The flow rate of the fuel gas can be controlled based on, for example, average flow rate Qₐᵥₑ of the fuel gas (fuel gas average flow rate) in the fuel gas channel. Fuel gas average flow rate Qₐᵥₑ is the average flow rate of the fuel gas which flows through the fuel gas channel, and the calculation method thereof is not particularly limited. For example, in the case where the fuel gas piping system is a circulation system as with fuel cell system 100, fuel gas average flow rate Qₐᵥₑ can be calculated by the following formula (1):

Qₐᵥₑ=Qₐ+Q_{b}/2 Formula (1)

Qₐᵥₑ: Average flow rate of fuel gas in fuel gas channel

Qₐ: Flow rate of the discharged fuel gas recirculated by the recirculation pump

Q_{b}: Flow rate of the fuel component gas supplied from the fuel supply means

In the above formula (1), fuel gas average flow rate Qₐᵥₑ is calculated based on the assumption that half of flow rate Q_{b} of the fuel component gas supplied from the fuel supply means in accordance with a required output is consumed in the middle of the overall length of the fuel gas channel.

Also, fuel gas average flow rate Qₐᵥₑ can be calculated by the following formula (2):

Qₐᵥₑ=nRT/P Formula (2)

Qₐᵥₑ: Average flow rate of the fuel gas in the fuel gas channel

n: Number of moles of the fuel gas in the middle of the overall length of the fuel gas channel

R: Gas constant

T: Fuel cell temperature

P: Pressure of the fuel gas in the middle of the overall length of fuel gas channel

In the above formula (2), the flow rate of the fuel gas in the middle of the overall length of the fuel gas channel is used as fuel gas average flow rate Qₐᵥₑ. Fuel gas average flow rate Qₐᵥₑ is calculated from the number of moles and pressure of the fuel gas in the middle of the overall length of the fuel gas channel, based on the equation of state of gas.

In formula (2), the number of moles of the fuel gas is a number of moles of the whole components contained in the fuel gas (nitrogen gas, hydrogen gas, water vapor and so on) in the middle of the overall length of the fuel gas channel. In particular, it is obtained by subtracting the number of moles of the fuel component which is consumed until it reaches the middle of the overall length of the fuel gas channel from the total number of moles of the fuel gas at the inlet of the fuel gas channel. The number of moles of the fuel component which is consumed until it reaches the middle of the overall length of the fuel gas channel, is half the amount of the fuel component which is needed based on a required output required for the fuel cell. Also, the total number of moles of the fuel gas at the inlet of the fuel gas channel is determined from the temperature and pressure of the total flow rate of the following: the flow rate of the fuel gas which is returned to the inlet of the fuel gas channel by the circulation pump and the flow rate of hydrogen which is additionally supplied from the hydrogen tank.

Also in formula (2), the pressure of the fuel gas can be one that is actually detected in the middle of the overall length of the fuel gas channel, or it can be the average calculated from pressures of the fuel gas which are measured at several positions of the overall length of the fuel gas channel. Or, the pressure of the fuel gas can be calculated based on the assumption that half of the pressure loss generated in the overall length of the fuel gas channel is caused in the middle the overall length of the fuel gas channel. The fuel gas pressure based on such an assumption of pressure loss can be calculated by the following formula (3):

P=(Pᵢₙ+Pₒᵤₜ)/2 Formula (3)

Pᵢₙ: Pressure of the fuel gas at the fuel gas channel inlet

Pₒᵤₜ: Pressure of the fuel gas at the fuel gas channel outlet

In the case where the fuel gas piping system is a circulation system, as a variation of formula (2), average flow rate Qₐᵥₑ of the fuel gas can be calculated by the following formula (4):

Qₐᵥₑ=n′RT/P Formula (4)

Qₐᵥₑ: Average flow rate of the fuel gas in the fuel gas channel

n′: Number of moles of the fuel gas in the middle of the overall length of the fuel gas channel, which is calculated based on the assumption that in the fuel gas which is supplied to the fuel gas channel, half of the fuel component which is supplied to the fuel gas channel by the fuel gas supply means, is consumed.

R: Gas constant

T: Fuel cell temperature

P: Pressure of the fuel gas in the middle of the overall length of fuel gas channel, which is calculated by the formula (3)

Other than the value calculated based on the above assumption, fuel gas average flow rate Qₐᵥₑ can be a value which is calculated by actually measuring the fuel rate of the fuel gas at several positions of the fuel gas channel and averaging them, or a flow rate of the fuel gas which is actually measured in the middle of the overall length of the fuel gas channel. From the point of view that the fuel cell system can be built easily, the fuel gas average flow rate is preferably calculated by formula (1), (2) or (4).

Fuel cell system 100 described above has a voltage sensor which detects and monitors the voltage of the fuel cell. The moisture state control means employs a feed back control which controls the flow rate and/or pressure of the fuel gas based on the voltage of the fuel cell detected by the voltage sensor; however, it can employ a feedforward control.

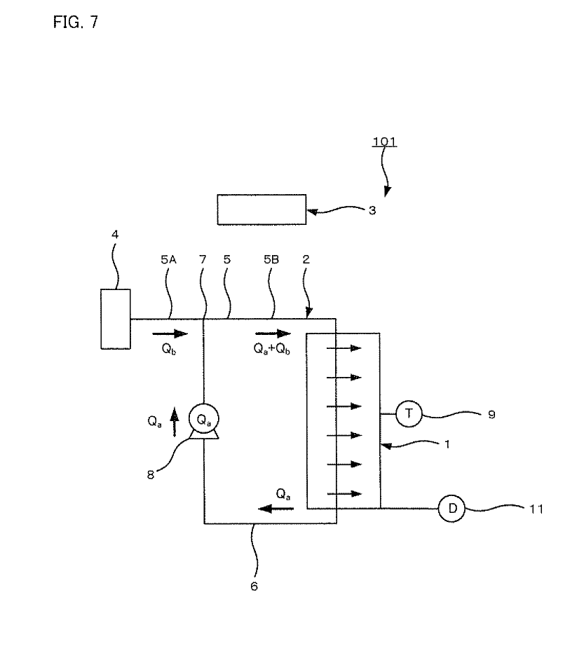

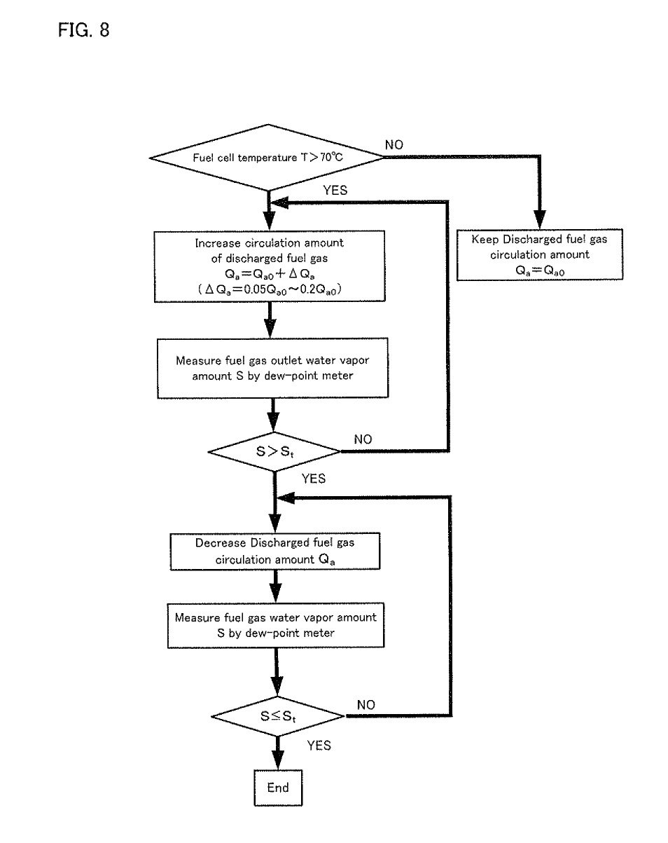

Hereinafter, fuel cell system 101 will be described with reference to FIGS. 7 and 8, which is a different illustrative embodiment of the present invention.

As shown in FIGS. 1 and 2, the inventors of the present invention have found out that there is a high correlation between the fuel gas outlet water vapor amount and the average flow rate of the fuel gas in the fuel gas channel (hereinafter may be referred to as fuel gas average flow rate). That is, they obtained the following knowledge: as shown in FIG. 2, when the average flow rate of the fuel gas in the fuel gas channel is low, the fuel gas outlet water vapor amount is small and the voltage of the fuel cell is low (the above-described state 1); when the fuel gas average flow rate is increased higher than state 1, the fuel gas outlet water vapor amount is very small and the fuel cell can be a high voltage (the above-described state 2); and when the fuel gas average flow rate is further increased higher than state 2, the fuel gas outlet water vapor amount is large and the voltage of the fuel cell is low (the above-described state 3). Furthermore, as shown in FIG. 2, since a consistent correlation is shown between the fuel gas outlet water vapor amount and the fuel gas average flow rate regardless of the pressure of the fuel gas in the fuel gas channel, the inventors of the present invention have found out that it is possible to control the moisture state of the fuel cell and obtain a stable output by using the fuel gas outlet water vapor amount as a criterion.

Fuel cell system 101 is based on the above knowledge. In fuel cell system 101, the moisture state control means controls the flow rate and/or pressure of the fuel gas so that once a water vapor amount at an outlet of the fuel gas channel is changed toward a high fuel gas outlet water vapor amount side which is higher than a target fuel gas outlet water vapor amount, it is decreased from the high fuel gas outlet water vapor amount to the target fuel gas outlet water vapor amount.

As shown in FIG. 7, fuel cell system 101 does not have voltage sensor 10; meanwhile, it has dew-point meter (water vapor amount measuring means) 11 at the outlet of the fuel gas channel, which measures water vapor amount S in the fuel gas, and it has the same structure as that of fuel cell system 101 shown in FIG. 5, except that the specific moisture state control process by the moisture state control means of controller 3 is different. Dew-point meter 11 can be installed in fuel gas piping system 2 as long as it can detect fuel gas outlet water vapor amount S.

Fuel cell system 101 will be described hereinafter, focusing on the differences with fuel cell system 100.

In fuel cell system 101, the moisture state control means controls the flow rate of the fuel gas so that once fuel gas outlet water vapor amount S which is detected and monitored by dew-point meter 11 is changed toward a high fuel gas outlet water vapor amount side, it is decreased from the high fuel gas outlet water vapor amount to target fuel gas outlet water vapor amount Sₜ.

The target fuel gas outlet water vapor amount is a fuel gas outlet water vapor amount when the moisture state at the inlet of the fuel gas channel is in the target moisture state. The target fuel gas outlet water vapor amount can be preliminarily obtained based on a correlation between the voltage of the fuel cell and the flow rate and/or pressure of the fuel gas in the fuel cell at a given temperature. Or, it can be determined based on the correlation between the actual fuel cell voltage when operating the fuel cell and the flow rate and/or pressure of the fuel gas in the fuel cell at a given temperature when operating the fuel cell. Or, this correlation can be stored to determine the target value of the subsequent controls. As with the target moisture state, the target fuel gas outlet water vapor amount can refer to a water vapor amount at one point at which the target moisture state can be achieved (the peak voltage can be obtained), or it can refer to a range in which the target moisture state can be achieved (the peak voltage can be obtained).

FIG. 8 shows a control flow example by the moisture state control means in fuel cell system 101. In FIG. 8, the moisture state control means controls the flow rate of the fuel gas based on fuel gas outlet water vapor amount S measured by the dew-point meter. While fuel cell system 100 detects and monitors the fuel cell voltage by the voltage sensor, fuel cell system 101 can omit a cell monitor such as a voltage sensor or resistance sensor, so that it can further simplify the control in the fuel cell system and reduce the cost of the fuel cell.

In FIG. 8, in the operation of fuel cell 1, the moisture state control means of controller 3 detects temperature T of fuel cell 1 by temperature sensor 9 to determine whether temperature T is 70° C. or less or more than 70° C.

If temperature T is 70° C. or less, the moisture state control means does not change circulation amount Qₐ of the discharged fuel gas and keeps the latest circulation amount Qₐ₀ of the discharged fuel gas.

On the other hand, if temperature T is more than 70° C., the moisture state control means increases circulation amount Qₐ of the discharged fuel gas by ΔQₐ from the latest circulation amount Qₐ₀. ΔQₐ can be appropriately determined; however, it is preferably, for example, within the range of 5% to 20% of Qₐ₀ in order to prevent the inside of the fuel cell from being in an excessively-dry state.

Next, the moisture state control means measures fuel gas outlet water vapor amount S by dew-point meter 11 to determine whether or not fuel gas outlet water vapor amount S is higher than target fuel gas outlet water vapor amount Sₜ.

If fuel gas outlet water vapor amount S is target fuel gas outlet water vapor amount Sₜ or less, the means returns to the step of increasing the circulation amount of the discharged fuel gas.

On the other hand, if fuel gas outlet water vapor amount S is more than target fuel gas outlet water vapor amount Sₜ, the means decreases discharged fuel gas circulation amount Qₐ. The decrease in discharged fuel gas circulation amount Qₐ is continued until fuel gas outlet water vapor amount S measured by dew-point meter 11 is target fuel gas outlet water vapor amount Sₜ or less.

When fuel gas outlet water vapor amount S is target fuel gas outlet water vapor amount Sₜ or less, the moisture state control means ends the process.

In the above flow, the discharged fuel gas circulation amount with which fuel gas outlet water vapor amount S becomes higher than target fuel gas outlet water vapor amount Sₜ and/or the discharged fuel gas circulation amount with which fuel gas outlet water vapor amount S becomes equal to or smaller than target fuel gas outlet water vapor amount Sₜ, can be stored and reflected in the subsequent moisture state controls.

In the flow shown in FIG. 8, the fuel gas outlet water vapor amount is controlled by controlling the flow rate Q of the fuel gas (specifically, discharged fuel gas flow rate Qₐ). However, as with fuel cell system 100, the controlled parameter for bringing fuel gas outlet water vapor amount S close to target water vapor amount Sₜ is not limited to the flow rate of the fuel gas. It can be the pressure of the fuel gas or both the flow rate and pressure of the fuel gas.

As described above, since there is a high correlation between the fuel gas average flow rate and the fuel gas outlet water vapor amount, the fuel gas outlet water vapor amount can be controlled indirectly by controlling the fuel gas average flow rate.

Therefore, the moisture state control means can be one which preliminarily obtains the fuel gas average flow rate that can make the fuel gas outlet water vapor amount a desired value or range based on the relationship between the fuel gas average flow rate and the fuel gas outlet water vapor amount, and which controls the flow rate and/or pressure of the fuel gas based on the thus-obtained average flow rate so that the fuel gas outlet water vapor amount is decreased from the high fuel gas outlet water vapor amount to the target fuel gas outlet water vapor amount.

In the present invention, as just described, in the case of controlling the flow rate and/or pressure of the fuel gas based on the preliminarily-obtained correlation between the fuel gas outlet water vapor amount and fuel gas average flow rate, it is possible to make the fuel gas outlet water vapor amount a desired value or range without a water vapor amount measuring means such as a dew-point meter. Therefore, a further simplification of the fuel cell system and cost reduction are possible.

### REFERENCE SIGNS LIST

1. Fuel cell
2. Fuel gas piping system
3. Controller
4. Hydrogen tank (Fuel supply means)
5. Fuel gas supply path
5A. Main path
5B. Mixing path
6. Fuel gas circulating path
7. Connecting part
8. Recirculation pump
9. Temperature sensor (Temperature measuring means)
10. Voltage sensor
11. Dew-point meter (Water vapor amount measuring means)
12. Single fuel cell
13. Polymer electrolyte membrane
14. Cathode electrode
15. Anode electrode
16. Membrane electrode assembly
17. Separator
18. Separator
19. Oxidant gas channel
20. Fuel gas channel
21. Cathode catalyst layer
22. Gas diffusion layer
23. Anode catalyst layer
24. Gas diffusion layer
100. Fuel cell system
101. Fuel cell system

1. A fuel cell system which comprises a fuel cell and is operated under a non-humidified condition,
the fuel cell comprising:
a polymer electrolyte membrane sandwiched between an anode electrode and a cathode electrode,
a fuel gas channel disposed so as to face the anode electrode in order to supply the anode electrode with fuel gas containing at least a fuel component, and
an oxidant gas channel disposed so as to face the cathode electrode in order to supply the cathode electrode with oxidant gas containing at least an oxidant component,
wherein a flow direction of the fuel gas in the fuel gas channel and a flow direction of the oxidant gas in the oxidant gas channel are opposite; and
wherein the fuel cell system has a moisture state control means which controls a flow rate and/or pressure of the fuel gas so that once a moisture state in an inlet region of the fuel gas channel is changed from the latest moisture state toward a low moisture state side which is lower than a target moisture state, it is changed from the low moisture state to the target moisture state.

2. The fuel cell system according to claim 1, wherein the moisture state control means changes the flow rate and/or pressure of the fuel gas by a given amount in order to change the moisture state toward the low moisture state side; thereafter, based on an amount of change in a predetermined parameter, which is associated with the given amount of change, it changes the flow rate and/or pressure of the fuel gas by a given amount in order to further change the moisture state toward the low moisture state side.

3. The fuel cell system according to claim 1, wherein once the moisture state control means increases the flow rate of the fuel gas toward a high fuel gas flow rate side which is higher than a target fuel gas flow rate, it decreases the flow rate of the fuel gas from the high fuel gas flow rate to the target fuel gas flow rate.

4. The fuel cell system according to claim 3, wherein the target fuel gas flow rate is preliminarily obtained based on a correlation between a voltage of the fuel cell and the flow rate and/or pressure of the fuel gas in the fuel cell at a given temperature.

5. The fuel cell system according to claim 1, comprising a voltage measuring means for measuring the voltage of the fuel cell,
wherein the moisture state control means ends the process of controlling the flow rate and/or pressure of the fuel gas so as to change the moisture state from the low moisture state to the target moisture state when it determines by the voltage measuring means that the voltage of the fuel cell reaches a target voltage.

6. The fuel cell system according to claim 1, comprising a voltage measuring means for measuring the voltage of the fuel cell,
wherein the moisture state control means has a calculation means which calculates a ratio of an amount of change in the voltage of the fuel cell to an amount of change in the flow rate or pressure of the fuel gas changed by the moisture state control means, based on the voltage of the fuel cell measured by the voltage measuring means, and
wherein the moisture state control means repeats the control of the flow rate and/or pressure of the fuel gas for changing the moisture state from the latest moisture state toward the low moisture state side, until the ratio is in a given range.

7. The fuel cell system according to claim 1, wherein the moisture state control means controls the flow rate and/or pressure of the fuel gas so that once a water vapor amount at an outlet of the fuel gas channel is changed toward a high fuel gas outlet water vapor amount side which is higher than a target fuel gas outlet water vapor amount, it is decreased from the high fuel gas outlet water vapor amount to the target fuel gas outlet water vapor amount.

8. The fuel cell system according to claim 7, wherein the target fuel gas outlet water vapor amount is preliminarily obtained based on a correlation between the voltage of the fuel cell and the flow rate and/or pressure of the fuel gas in the fuel cell at a given temperature.

9. The fuel cell system according to claim 7, comprising a water vapor amount measuring means for measuring the water vapor amount at the outlet of the fuel gas channel,
wherein the moisture state control means ends the process of controlling the flow rate and/or pressure of the fuel gas when it determines by the water vapor amount measuring means that the water vapor amount at the fuel gas channel outlet is changed from the high fuel gas outlet water vapor amount to the target fuel gas outlet water vapor amount.

10. The fuel cell system according to claim 1, wherein the moisture state control means starts the control of the flow rate and/or pressure of the fuel gas when the fuel cell reaches a temperature of 70° C. or more.
